(19) United States
(12) Patent Application Publication
(10) Pub. No.: US 2025/0036480 A1
(43) Pub. Date: Jan. 30, 2025

(54) METHODS AND APPARATUS TO RESOLVE CONFLICTS BETWEEN MULTIPLE AUTOMATION SYSTEMS

(71) Applicant: VMware LLC, Palo Alto, CA (US)

(72) Inventors: Saifuddin Fazlehusen Rangwala, Pune (IN); Amit Meena, Pune (IN)

(21) Appl. No.: 18/357,837

(22) Filed: Jul. 24, 2023

(51) Int. Cl. G06F 9/50

(52) U.S. Cl. CPC G06F 9/5077; G06F 9/5072

(57) ABSTRACT

Systems, apparatus, articles of manufacture, and methods are disclosed to resolve conflicts between multiple automation systems. An example apparatus includes interface circuitry, machine readable instructions, and programmable circuitry to at least one of instantiate or execute the machine readable instructions to: cause storage of records indicative of configuration changes made to a computing resource; generate a time series based on the records; analyze the time series to determine if a configuration change conflict is detected; and after detection of a configuration change conflict, generate a notification of the configuration change conflict.

### FIELD OF THE DISCLOSURE

This disclosure relates generally to cloud computing and, more particularly, to methods and apparatus to resolve conflicts between multiple automation systems.

### BACKGROUND

Cloud computing is the delivery of computing resources including storage, processing power, databases, networking, analytics, artificial intelligence, and software applications via a networked data center. Cloud servers can include compute, memory, and/or storage resources to remotely perform services and functions for an organization. Cloud servers sometimes require a security infrastructure to prevent cyber-attacks and system-wide manipulations of data within the cloud computing system.

### BRIEF DESCRIPTION OF THE DRAWINGS

FIG. 1 is a schematic block diagram of an example environment in which an example configuration monitor circuitry operates to detect configuration change conflicts.

FIG. 2 is a block diagram of the example implementation of the configuration change monitor circuitry of FIG. 1.

FIG. 3 is a flowchart representative of example machine readable instructions and/or example operations that may be executed, instantiated, and/or performed by example programmable circuitry to implement the configuration monitor circuitry of FIG. 2.

FIG. 4 is a block diagram of an example processing platform including programmable circuitry structured to execute, instantiate, and/or perform the example machine readable instructions and/or perform the example operations of FIG. 3 to implement the configuration monitor circuitry of FIGS. 1-2.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

### DETAILED DESCRIPTION

There are many automation/management systems that exist to manage various aspects of resource configurations in computing environments (e.g., public cloud environments, private cloud environments, hardware appliances, and/or software defined computing environments). As these automation systems mature, the scope of management boundaries continues expanding. This expansion may lead to multiple systems trying to manage the same set of configurations for a given resource. Such an approach results in configuration change conflicts and the automation systems may drift away from the desired state of configuration and become unmanageable over a period of time.

For example, a cloud computing configuration may be provisioned by a provisioning tool, but then monitored and changed by a security configuration management tool. Generally, such automation tools may be used by different teams and there may be little or no visibility of conflicting changes in any single tool. Similarly, configuration of a cloud computing instance may be monitored and changed by a cost monitoring tool, but can be provisioned by many other mechanisms. Generally, these systems perform an action only when they detect that there is a violation of some policies. Sometimes, when a violation is detected and a configuration is changed in response, such change creates churn as another tool attempts to apply a conflicting change.

Methods and apparatus disclosed herein utilize a configuration monitor that brings together policy configurations of different systems into a template or a console. In some examples, the configuration monitor continuously monitors configurations (e.g., on a schedule, on a near-real-time basis, etc.) for changes. In some examples, such a configuration monitor can understand configuration change conflicts between the different systems. When a configuration change conflict is detected, the configuration monitor may notify the system and notify the user of the configuration change conflict and/or take additional actions (e.g., modify a configuration, modify a configuration setting of one of the systems, etc.).

Example methods and apparatus receive a policy or resource configuration (e.g., in the form of a template). For example, a user may define a template that specifies configuration settings of one or more cloud resources. An example template includes definitions of multiple resources and/or policies known as states. A template may be generic in that it can be applied to any infrastructure. Example templates are created with a desired state intent, which means when templates are enforced:

1. If the resource or a configuration definition does not already exist, it will be created.

2. If the resource or configuration definition already exists, but the current definition is not same as desired configuration, then it will be corrected.

Both of the foregoing situations are classified as drift. Methods and apparatus disclosed herein facilitate the identification of such drift. In some examples, machine learning, artificial intelligence, and/or other techniques may be utilized to detect drift. An example method includes recording changes made by a configuration monitor in the form of a record (e.g., a record may include a desired state identifier, an entity identifier, a drift indication, and a timestamp), forming time series data indicative of drift over various periods of time, analyzing the time series data for seasonality or a pattern in the drift for a given entity, and, if seasonality is found, flagging a potential configuration change conflict and the desired states associated with the entity for further enforcements. In some examples, the configuration monitor does not inspect the content of the definitions to identify the configuration change conflicts, but, rather, inspects the behavior of drifts. Accordingly, the configuration monitor can identify configuration change conflicts with any known or unknown system.

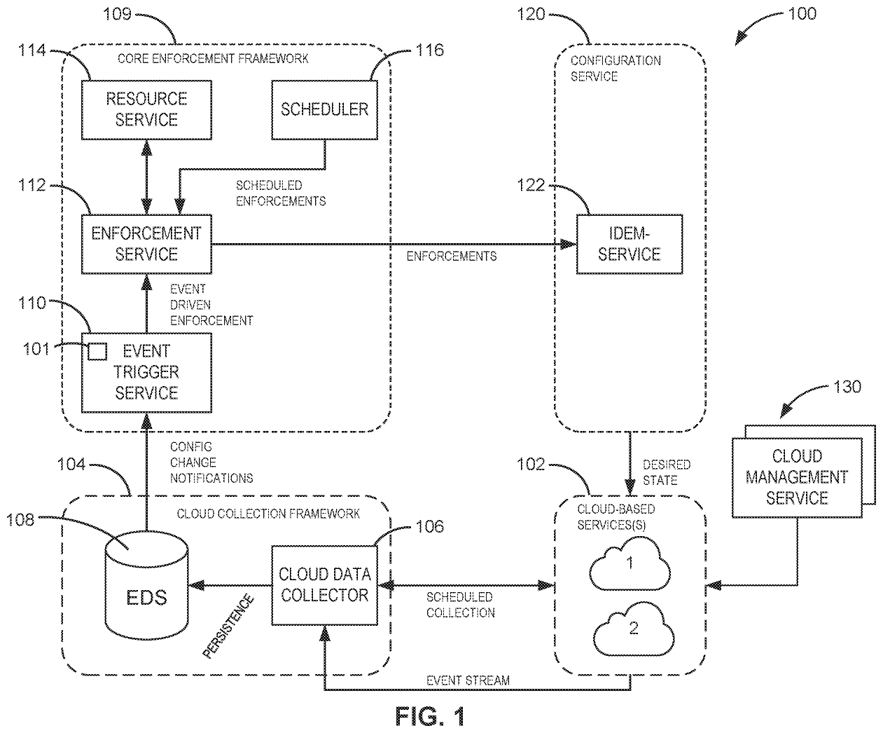

FIG. 1 is a schematic block diagram of an example environment 100 in which an example configuration monitor circuitry 101 monitors configurations in computing systems (e.g., in cloud computing systems). In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110 that implements the aforementioned configuration monitor circuitry 101, an example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples the event trigger service 110 intercepts the configuration/metadata update in the EDS 108 and triggers the enforcements via the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102. In other words, the IDEM service 122 controls a desired state of the cloud service(s) 122 based on enforcements provided from the enforcement service 112. While the configuration monitor circuitry 101 is shown implemented in the example event trigger service 110, additionally or alternatively, the configuration monitor circuitry 101 can be implemented in the enforcement service 112, the resource service 114 and/or the scheduler 116.

The example environment includes one or more cloud management services 130. The cloud management services are any type of tool, control, service, etc. that can affect the configuration, settings, parameters, operations, etc. of the cloud based services 102. For example, the cloud management services 130 may include a security configuration tool, a provisioning tool, cost monitoring tool, a performance monitoring tool, etc. The various cloud management services 130 may be operated by different entities and/or individuals. Accordingly, the operation of the various cloud management services 130 may not be coordinated and, thus, may result in conflicting changes that cause drift that may be monitored by the configuration monitor circuitry 101.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

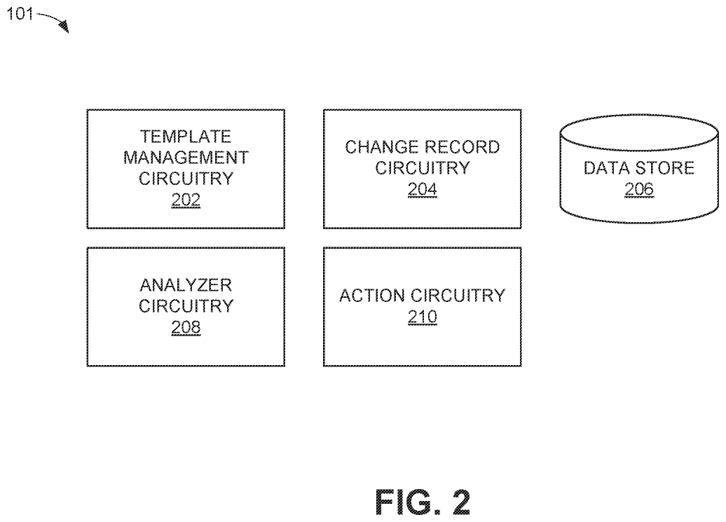

FIG. 2 is a block diagram of an example implementation of the cloud monitor circuitry 101 of FIG. 1. The example cloud monitor circuitry 101 includes an example template management circuitry 202, an example change record circuitry 204, an example data store 206, an example analyzer circuitry 208, and an example action circuitry 210.

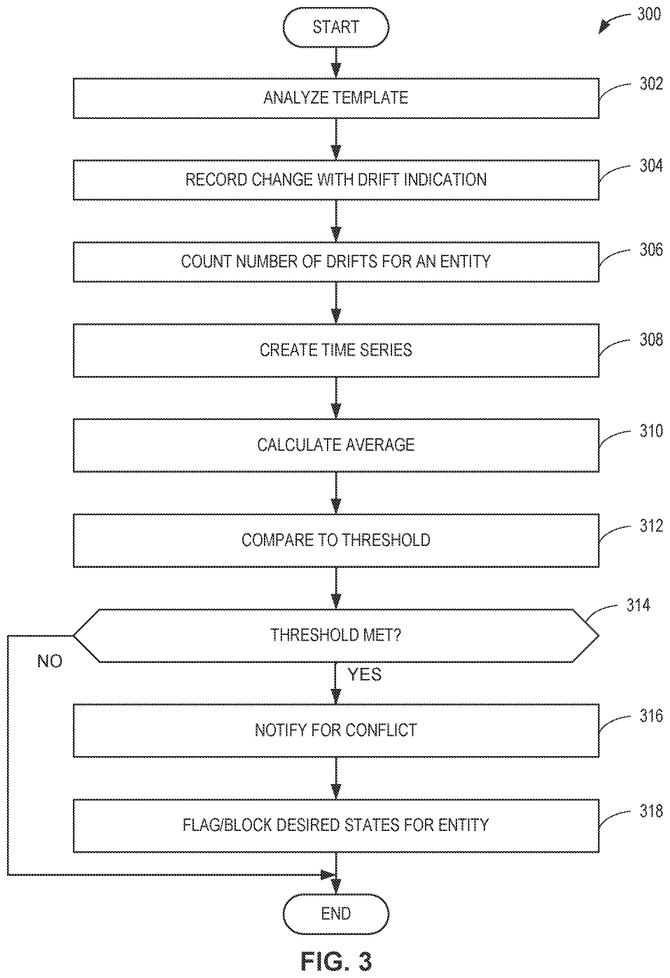

The example template management circuitry 202 receives a user-input template identifying configuration information of a definition of multiple resources and/or policies (e.g., known as states). According to the illustrated example, a template is generic and can be applied to any type of infrastructure. The template management circuitry 202 may provide a user interface for a user to enter template information, to provide a template file, etc. In some examples, the template management circuitry 202 is instantiated by programmable circuitry executing template management instructions and/or configured to perform operations such as those represented by the flowchart(s) of FIG. 3.

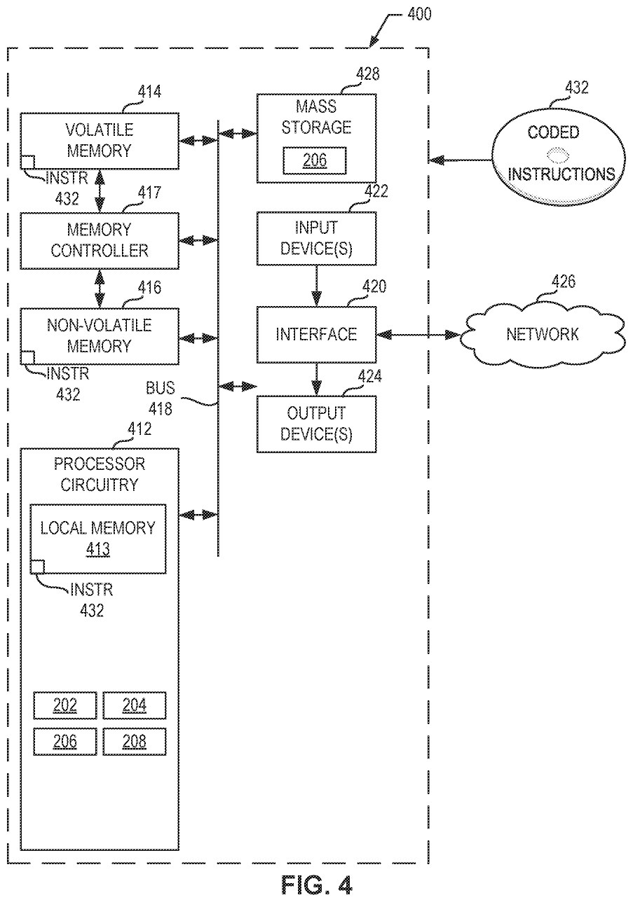

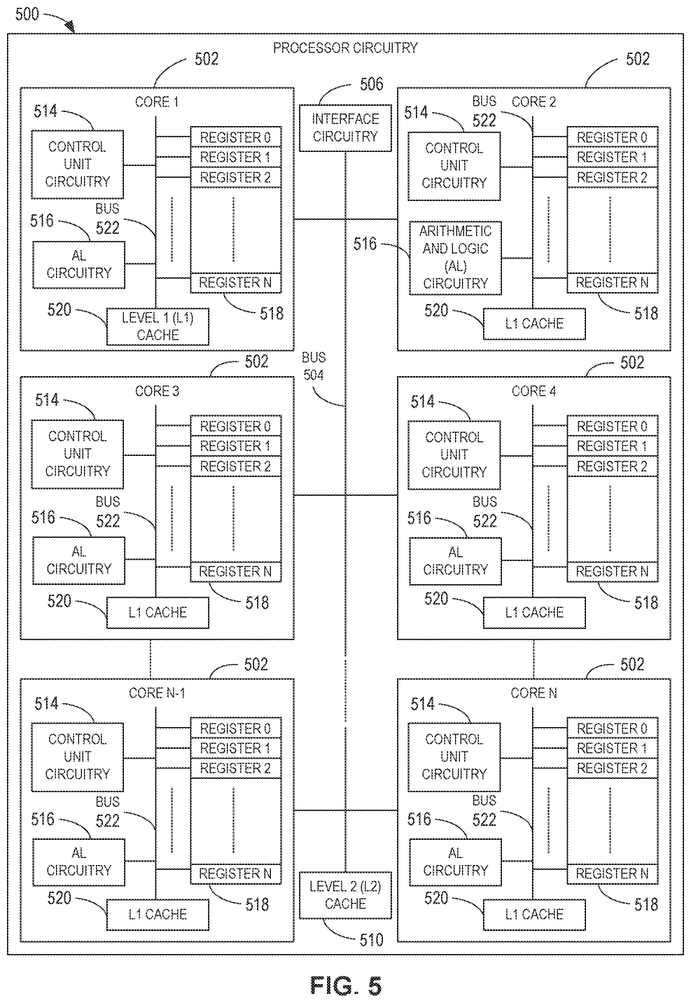

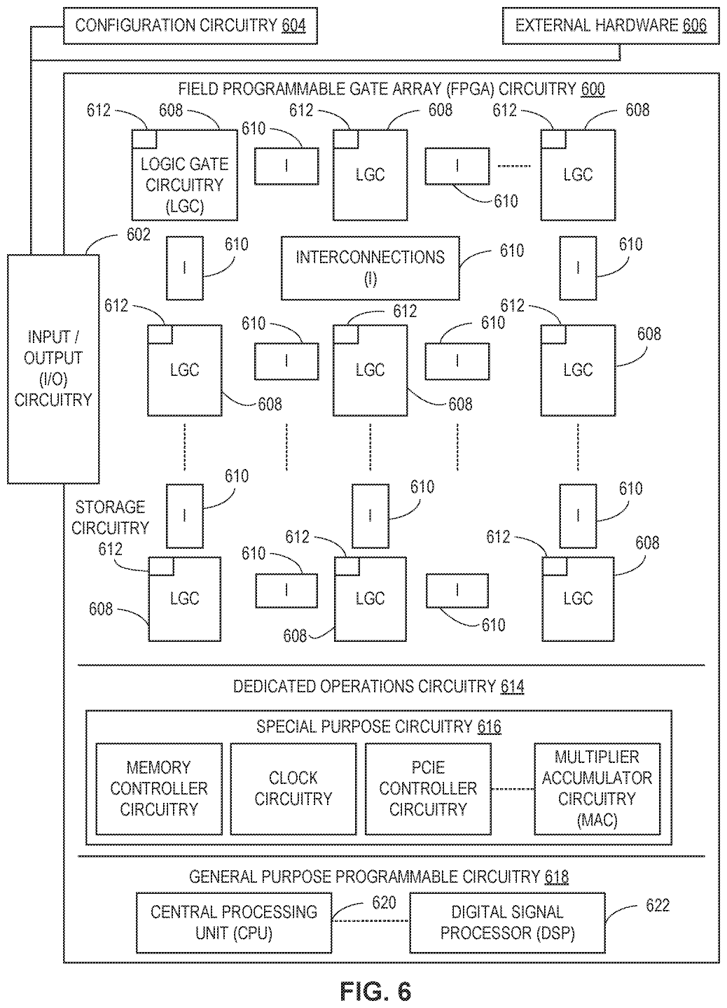

In some examples, the configuration monitor circuitry 101 includes means for template management. For example, the means for template management may be implemented by template management circuitry 202. In some examples, the template management circuitry 202 may be instantiated by programmable circuitry such as the example programmable circuitry 412 of FIG. 4. For instance, the template management circuitry 202 may be instantiated by the example microprocessor 500 of FIG. 5 executing machine executable instructions such as those implemented by at least block 302 of FIG. 3. In some examples, the template management circuitry 202 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the template management circuitry 202 may be instantiated by any other combination of hardware, software, and/or firmware. For example, the template management circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The change record circuitry 204 records information about configuration changes. For example, the event trigger service 110 may detect an event for which the enforcement service 112 will enforce a configuration change. The example change record circuitry 204 stores the record of change information in the example data store 206. The example record includes a desired state identifier, an entity identifier, a timestamp, and an indication of whether or not drift was determined. According to the illustrated example, if a configuration change was made, drift will be True, else False. Alternatively, other criteria may be utilized to detect drift. For example, a machine learning or artificial intelligence approach may be utilized to analyze various factors including the details of the configuration change, a configuration change history, a source of a change that led to the need for the configuration change, etc. An instance of desired state is specific to a particular infrastructure and states enforced by a desired state are translated to specific instances of a policy configuration in a target policy engine or a resource definition in target infrastructure, which is called an entity. An entity will have an identifier (e.g., a unique identifier) called an entity identifier.

In some examples, the change record circuitry 204 is instantiated by programmable circuitry executing template management instructions and/or configured to perform operations such as those represented by the flowchart(s) of FIG. 3.

In some examples, the configuration monitor circuitry 101 includes means for creating a change record. For example, the means for creating a change record may be implemented by change record circuitry 204. In some examples, the change record circuitry 204 may be instantiated by programmable circuitry such as the example programmable circuitry 412 of FIG. 4. For instance, the change record circuitry 204 may be instantiated by the example microprocessor 500 of FIG. 5 executing machine executable instructions such as those implemented by at least block 304 of FIG. 3. In some examples, the change record circuitry 204 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the change record circuitry 204 may be instantiated by any other combination of hardware, software, and/or firmware. For example, the change record circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example data store 206 is a database for storing records of change information. Alternatively, any other type of data storage may be utilized such as a file, a memory, a physical disk, a flash memory, and/or any number and/or combination of storage types, devices, protocols, etc.

The example analyzer circuitry 208 analyzes the record information stored in the example data store 206 to determine if a configuration change conflict is detected (e.g., if multiple tools/operations are changing data in a conflicting way and/or if a tool is changing data in a way that conflicts with a desired state enforced by the core enforcement framework).

The example analyzer circuitry 208 generates multiple time series based on the record. For example, the analyzer circuitry 208 of the illustrated example generates a time series based on counting drift indicates across multiple time period (e.g., hourly, daily, weekly, monthly). An example time series is generated according to the following formula: y(t)=1 IF COUNTIF(drift(t) is True))>0 ELSE 0, where the period t may be instance, hour, day, week, month. In other words, COUNT the number of drifts fixed over the period t for a given entity identifier and, if the COUNT >0, then y(t)=1, else y(t)=0. The identifier t indicates that for all records reported in a given period (e.g., hourly, daily, weekly, monthly), count the number of drifts fixed and, if the number of drifts fixed in that time period >0, then y(t) is 1, else 0.

The example analyzer circuitry 208 also performs analysis of the time series to determine if a configuration change conflict is detected. The example analyzer circuitry 208 performs a moving average (e.g., a simple moving average) of the data and compares the moving average to a threshold (e.g., 1) to determine a configuration change conflict when the moving average meets the threshold (e.g., greater than or equal to 1). The order of the moving average may be selected and/or adjusted (e.g., may be a user setting) to control how aggressively and/or quickly configuration change conflicts are detected. For example, for a given order N of the moving average approach can detect a configuration change conflict within N−1 periods. Thus, a smaller N (e.g., 2, 3, etc.) will help to aggressively and quickly detect configuration change conflicts. Alternatively, a larger N (e.g., 10,15, etc.) to provide additional time before concluding that a configuration change conflict is present to reduce the number of false positives.

In some examples, the analyzer circuitry 208 is instantiated by programmable circuitry executing analyzer instructions and/or configured to perform operations such as those represented by the flowchart(s) of FIG. 3.

In some examples, the configuration monitor circuitry 101 includes means for analyzing. For example, the means for analyzing may be implemented by analyzer circuitry 208. In some examples, the analyzer circuitry 208 may be instantiated by programmable circuitry such as the example programmable circuitry 412 of FIG. 4. For instance, the analyzer circuitry 208 may be instantiated by the example microprocessor 500 of FIG. 5 executing machine executable instructions such as those implemented by at least blocks 306-312 of FIG. 3. In some examples, the analyzer circuitry 208 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the analyzer circuitry 208 may be instantiated by any other combination of hardware, software, and/or firmware. For example, the analyzer circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example action circuitry 210 performs an action on a conflict detection by the analyzer circuitry 208. According to the illustrated example, the action circuitry 210 provides a notification of a detected configuration change conflict and flags and/or blocks the desired states for the entity for which the configuration change conflict was detected. Alternatively, any other type of action may be performed such as remediating a configuration change conflict, blocking a tool/operation/system/user that is causing the configuration change conflict to occur, updating a desired state, providing a user interface for a user to select an action, and/or any combination of available actions.

In some examples, the action circuitry 210 is instantiated by programmable circuitry executing action instructions and/or configured to perform operations such as those represented by the flowchart(s) of FIG. 3.

In some examples, the configuration monitor circuitry 101 includes means for creating a change record. For example, the means for creating a change record may be implemented by action circuitry 210. In some examples, the action circuitry 210 may be instantiated by programmable circuitry such as the example programmable circuitry 412 of FIG. 4. For instance, the action circuitry 210 may be instantiated by the example microprocessor 500 of FIG. 5 executing machine executable instructions such as those implemented by at least blocks 316-318 of FIG. 3. In some examples, the action circuitry 210 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the action circuitry 210 may be instantiated by any other combination of hardware, software, and/or firmware. For example, the action circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the configuration monitor circuitry 101 of FIG. 1 is illustrated in FIG. 2, one or more of the elements, processes, and/or devices illustrated in FIG. 2 may be combined, divided, re-arranged, omitted, eliminated, and/or implemented in any other way. Further, the example template management circuitry 202, the example change record circuitry 204, the example analyzer circuitry 208, the example action circuitry 210, and/or, more generally, the example configuration monitor circuitry 101 of FIG. 2, may be implemented by hardware alone or by hardware in combination with software and/or firmware. Thus, for example, any of the example template management circuitry 202, the example change record circuitry 204, the example analyzer circuitry 208, the example action circuitry 210, and/or, more generally, the example configuration monitor circuitry 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example configuration monitor circuitry 101 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the configuration monitor circuitry 101 of FIG. 2 and/or representative of example operations which may be performed by programmable circuitry to implement and/or instantiate the configuration monitor circuitry 101 of FIG. 2, are shown in FIG. 3. The machine readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 3, many other methods of implementing the example configuration monitor circuitry 101 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to detect drift and conflicts in configuration of computing resources such as cloud resources. The example machine-readable instructions and/or the example operations 300 of FIG. 3 begin at block 302, at which the template management circuitry 202 analyzes templates to determine desired states for configuration of a computing resource. The example change record circuitry 204 records a change with a drift indication (e.g., true or false) (block 304). For example, any time a configuration change is made, a record is stored with an indication that drift is true. Any time that an analysis of a resource state reveals that a change is not needed a record may be stored with an indication that drift is false. Alternatively, a record may only be stored when a change (e.g., a drift is detected).

Periodically (e.g., or aperiodically, scheduled, randomly, triggered etc.) the example analyzer circuitry 208 begins an analysis of the stored data by counting a number of drifts for an entity (block 306) and determining a time series of the data (block 308). According to the illustrated example, the drifts are counted over various periods (e.g., hourly, daily, weekly, monthly) to generate multiple time series. For example, for an hourly period, the number of drifts in hour 0 are counted and the value of the time series for hour 0 is 1 if any drifts are detected and is 0 if no drifts are detected, then the number of drifts in hour 1 are counted and the value of the time series for hour 1 is 1 if any drifts are detected and is 0 if no drifts are detected, etc.

The example analyzer circuitry 208 then analyzes the time series data (e.g., by computing a moving average of the time series) (block 310). The analyzer circuitry 208 compares the moving average to a threshold (e.g., 1) (block 312). When the moving average does not meet the threshold (e.g., does not exceed, does not equal or exceed, etc.) the analyzer circuitry 208 determines that a configuration change conflict is not detected and the process of FIG. 3 ends (block 314).

When the analyzer circuitry 208 determines that the threshold is met (block 314), the example action circuitry 210 provides a notification of a detected configuration change conflict (block 316). For example, the notification may indicate the entity identifier associated with the configuration change conflict, may indicate the time period associated with the configuration change conflict detection, may indicate that moving average value as an indication of the likelihood of the configuration change conflict, may indicate a history of configuration change conflicts, may indicate each instance at which drift was detected, may indicate the threshold value, etc. In various implementations, different types of thresholds may be utilized. Thus, a threshold may be met when the threshold is breached, when the threshold is exceeded, when a value drops below the threshold, when a value equals the threshold, etc. The example action circuitry 210 additionally flags the desired states and blocks further enforcement of the desired states (block 318). In some examples, the notification may include an indication of the actions performed (e.g., desired state is blocked from enforcement) and/or provide an instruction on how to re-enable enforcement and/or provide an interface that allows a user to request that enforcement resume.

FIG. 4 is a block diagram of an example programmable circuitry platform 400 structured to execute and/or instantiate the example machine-readable instructions and/or the example operations of FIG. 3 to implement the configuration monitor circuitry 101 of FIG. 2. The programmable circuitry platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the example template management circuitry 202, the example change record circuitry 204, the example analyzer circuitry 208, and the example action circuitry 210.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. The example mass storage device 428 includes the example data store 206.

The machine readable instructions 432, which may be implemented by the machine readable instructions of FIG. 3, may be stored in the mass storage device 428, in the volatile memory 414, in the non-volatile memory 416, and/or on at least one non-transitory computer readable storage medium such as a CD or DVD which may be removable.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowcharts of FIG. 3 to effectively instantiate the circuitry of FIG. 2 as logic circuits to perform operations corresponding to those machine readable instructions. In some such examples, the circuitry of FIG. 2 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart of FIG. 3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 600 may be configured and/or structured to effectively instantiate some or all of the operations/functions corresponding to the machine readable instructions of the flowchart of FIG. 3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIG. 3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIG. 3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 6. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart of FIG. 3 to perform first operation(s)/function(s), the FPGA circuitry 600 of FIG. 6 may be configured and/or structured to perform second operation(s)/function(s) corresponding to a second portion of the machine readable instructions represented by the flowcharts of FIG. 3, and/or an ASIC may be configured and/or structured to perform third operation(s)/function(s) corresponding to a third portion of the machine readable instructions represented by the flowcharts of FIG. 3.

It should be understood that some or all of the circuitry of FIG. 2 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIG. 2 may be implemented within one or more virtual machines and/or containers executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIG. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

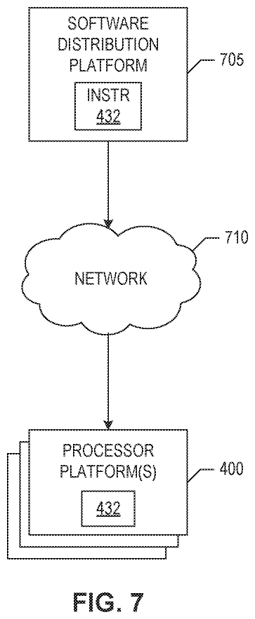

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIG. 3, as described above. The one or more servers of the example software distribution platform 705 are in communication with an example network 710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIG. 3, may be downloaded to the example programmable circuitry platform 400, which is to execute the machine readable instructions 432 to implement the configuration monitor circuitry 101. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

Example methods, apparatus, systems, and articles of manufacture to resolve conflicts between multiple automation systems are disclosed herein. Further examples and combinations thereof include the following:

Example 1 includes an apparatus comprising interface circuitry, machine readable instructions, and programmable circuitry to at least one of instantiate or execute the machine readable instructions to cause storage of records indicative of configuration changes made to a computing resource, generate a time series based on the records, analyze the time series to determine if a configuration change conflict is detected, and after detection of a configuration change conflict, generate a notification of the configuration change conflict.

Example 2 includes an apparatus as defined in example 1, wherein the configuration change conflict is triggered by a third party configuration that conflicts with a configuration state identified by the apparatus.

Example 3 includes an apparatus as defined in example 1, wherein the computing resource is a cloud computing resource.

Example 4 includes an apparatus as defined in example 1, wherein the programmable circuitry is to calculate an average of the time series.

Example 5 includes an apparatus as defined in example 4, wherein the average is a simple moving average.

Example 6 includes an apparatus as defined in example 1, wherein the programmable circuitry is to generate multiple time series with different periods.

Example 7 includes an apparatus as defined in example 6, wherein the periods are hourly, daily, weekly, and monthly.

Example 8 includes an apparatus as defined in example 1, wherein the programmable circuitry is to compare the analyzed time series to a threshold to determine if a conflict is detected.

Example 9 includes an apparatus as defined in example 1, wherein, after the configuration change conflict is detected, the programmable circuitry is to block enforcement of a desired state associated with the configuration change conflict.

Example 10 includes a non-transitory computer readable medium comprising instructions that, when executed, cause a machine to cause storage of records indicative of configuration changes made to a computing resource, generate a time series based on the records, analyze the time series to determine if a configuration change conflict is detected, and after detection of a configuration change conflict, generate a notification of the configuration change conflict.

Example 11 includes a non-transitory computer readable medium as defined in example 10, wherein the configuration change conflict is triggered by a third party configuration that conflicts with a configuration state identified by the apparatus.

Example 12 includes a non-transitory computer readable medium as defined in example 10, wherein the computing resource is a cloud computing resource.

Example 13 includes a non-transitory computer readable medium as defined in example 10, wherein the instructions, when executed, cause the machine to calculate an average of the time series.

Example 14 includes a non-transitory computer readable medium as defined in example 13, wherein the average is a simple moving average.

Example 15 includes a non-transitory computer readable medium as defined in example 10, wherein the instructions, when executed, cause the machine to generate multiple time series with different periods.

Example 16 includes a non-transitory computer readable medium as defined in example 15, wherein the periods are hourly, daily, weekly, and monthly.

Example 17 includes a non-transitory computer readable medium as defined in example 10, wherein the instructions, when executed, cause the machine to compare the analyzed time series to a threshold to determine if a conflict is detected.

Example 18 includes a non-transitory computer readable medium as defined in example 10, wherein, after the configuration change conflict is detected, wherein the instructions, when executed, cause the machine to block enforcement of a desired state associated with the configuration change conflict.

Example 19 includes a method comprising storing records indicative of configuration changes made to a computing resource, generating a time series based on the records, analyzing the time series to determine if a configuration change conflict is detected, and after detection of a configuration change conflict, generate a notification of the configuration change conflict.

Example 20 includes a method as defined in example 19, wherein the configuration change conflict is triggered by a third party configuration that conflicts with a configuration state identified by the apparatus.

Example 21 includes a method as defined in example 19, wherein the computing resource is a cloud computing resource.

Example 22 includes a method as defined in example 19, further comprising calculating an average of the time series.

Example 23 includes a method as defined in example 22, wherein the average is a simple moving average.

Example 24 includes a method as defined in example 19, further comprising generating multiple time series with different periods.

Example 25 includes a method as defined in example 24, wherein the periods are hourly, daily, weekly, and monthly.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
cause storage of records indicative of configuration changes made to a computing resource;
generate a time series based on the records;
analyze the time series to determine if a configuration change conflict is detected; and
after detection of a configuration change conflict, generate a notification of the configuration change conflict.

2. An apparatus as defined in claim 1, wherein the configuration change conflict is triggered by a third party configuration that conflicts with a configuration state identified by the apparatus.

3. An apparatus as defined in claim 1, wherein the computing resource is a cloud computing resource.

4. An apparatus as defined in claim 1, wherein the programmable circuitry is to calculate an average of the time series.

5. An apparatus as defined in claim 4, wherein the average is a simple moving average.

6. An apparatus as defined in claim 1, wherein the programmable circuitry is to generate multiple time series with different periods.

7. An apparatus as defined in claim 6, wherein the periods are hourly, daily, weekly, and monthly.

8. An apparatus as defined in claim 1, wherein the programmable circuitry is to compare the analyzed time series to a threshold to determine if a conflict is detected.

9. An apparatus as defined in claim 1, wherein, after the configuration change conflict is detected, the programmable circuitry is to block enforcement of a desired state associated with the configuration change conflict.

10. A non-transitory computer readable medium comprising instructions that, when executed, cause a machine to:
cause storage of records indicative of configuration changes made to a computing resource;
generate a time series based on the records;
analyze the time series to determine if a configuration change conflict is detected; and
after detection of a configuration change conflict, generate a notification of the configuration change conflict.

11. A non-transitory computer readable medium as defined in claim 10, wherein the configuration change conflict is triggered by a third party configuration that conflicts with a configuration state identified by the apparatus.

12. A non-transitory computer readable medium as defined in claim 10, wherein the computing resource is a cloud computing resource.

13. A non-transitory computer readable medium as defined in claim 10, wherein the instructions, when executed, cause the machine to calculate an average of the time series.

14. A non-transitory computer readable medium as defined in claim 13, wherein the average is a simple moving average.

15. A non-transitory computer readable medium as defined in claim 10, wherein the instructions, when executed, cause the machine to generate multiple time series with different periods.

16. A non-transitory computer readable medium as defined in claim 15, wherein the periods are hourly, daily, weekly, and monthly.

17. A non-transitory computer readable medium as defined in claim 10, wherein the instructions, when executed, cause the machine to compare the analyzed time series to a threshold to determine if a conflict is detected.

18. A non-transitory computer readable medium as defined in claim 10, wherein, after the configuration change conflict is detected, wherein the instructions, when executed, cause the machine to block enforcement of a desired state associated with the configuration change conflict.

19. A method comprising:
storing records indicative of configuration changes made to a computing resource;
generating a time series based on the records;
analyzing the time series to determine if a configuration change conflict is detected; and
after detection of a configuration change conflict, generate a notification of the configuration change conflict.

20. A method as defined in claim 19, wherein the configuration change conflict is triggered by a third party configuration that conflicts with a configuration state identified by the apparatus.

21. A method as defined in claim 19, wherein the computing resource is a cloud computing resource.

22. A method as defined in claim 19, further comprising calculating an average of the time series.

23. A method as defined in claim 22, wherein the average is a simple moving average.

24. A method as defined in claim 19, further comprising generating multiple time series with different periods.

25. A method as defined in claim 24, wherein the periods are hourly, daily, weekly, and monthly.
